(19) United States
(12) Patent Application Publication
(10) Pub. No.: US 2024/0214920 A1
(43) Pub. Date: Jun. 27, 2024

(54) ENHANCED LINK ADVERTISING IN MULTI-LINK OPERATION

(71) Applicant: CANON KABUSHIKI KAISHA, Tokyo (JP)

(72) Inventors: Julien SEVIN, SAINT AUBIN DU CORMIER (FR); Stéphane BARON, LE RHEU (FR); Romain GUIGNARD, RENNES (FR); Mickael LORGEOUX, RENNES (FR)

(21) Appl. No.: 18/555,841

(22) PCT Filed: Mar. 15, 2022
(86) PCT No.: PCT/EP2022/056766

§ 371 Date: Oct. 17, 2023

(30) Foreign Application Priority Data
Apr. 20, 2021 (GB) 2105610.6

(51) Int. Cl. H04W 48/20; H04W 76/15

(52) U.S. Cl. CPC H04W 48/20; H04W 76/15

(57) ABSTRACT

In wireless networks implementing multilink transmissions, a non-AP Multi-Link Device, MLD, discovers an AP MLD and registers to it. To reduce risks of registration refusal from the AP MLD, the invention proposes mechanisms to enhance link advertising in exchanged management frames. In embodiments, the beacon frames or probe response frames during ML discovery categorize the Per-STA profiles of the reported affiliated APs. Such categorization is a recommendation from the AP MLD to promote or favor some links or affiliated APs compared to others. Lists of profiles per category can be provided or each profile can be tagged with a dedicated categorizing score. In other embodiments, the non-AP MLD indicates one or more backup links as alternatives to one or more of the setup links requested for ML setup. This allows the AP MLD to switch on a backup link in case a setup link is to be refused.

### FIELD OF THE INVENTION

The present invention generally relates to wireless communications and more specifically to Multi-Link (ML) communication.

### BACKGROUND OF THE INVENTION

Wireless communication networks are widely deployed to provide various communication services such as voice, video, packet data, messaging, broadcast, etc. These wireless networks may be multiple-access networks capable of supporting multiple users by sharing the available network resources. Examples of such multiple-access networks include Code Division Multiple Access (CDMA) networks, Time Division Multiple Access (TDMA) networks, Frequency Division Multiple Access (FDMA) networks, Orthogonal FDMA (OFDMA) networks, and Single-Carrier FDMA (SC-FDMA) networks.

The 802.11 family of standards adopted by the Institute of Electrical and Electronics Engineers (IEEE-RTM) provides a great number of mechanisms for wireless communications between stations.

With the development of latency sensitive applications such as online gaming, real-time video streaming, virtual reality, drone or robot remote controlling, better throughput, low latency and robustness requirements and issues need to be taken into consideration. Such problematic issues are currently under consideration by the IEEE 802.11 working group as a main objective to issue the next major 802.11 release, known as 802.11be or EHT for “Extremely High Throughput”.

The IEEE P802.11be/D0.4 version (March 2021) introduces the Multi-link (ML) operation (MLO). MLO improves data throughput by allowing communications between stations over multiple concurrent and non-contiguous communication links.

Multi-link operation (MLO) enables a non-AP (access point) MLD (ML device) to register with an AP MLD, i.e. to discover, authenticate, associate and set up multiple links with the AP MLD. Each link enables channel access and frame exchanges between the non-AP MLD and the AP MLD based on supported capabilities exchanged during association.

A MLD is a logical entity that has more than one affiliated station (STA) and has a single medium access control (MAC) service access point (SAP) to logical link control (LLC), which includes one MAC data service. An AP MLD is thus made of multiple affiliated APs whereas a non-AP MLD is made of multiple affiliated non-AP stations. The affiliated stations in both AP MLD and non-AP-MLD can use 802.11 mechanisms to communicate with affiliated stations of another MLD over each of the multiple communication links that are set up.

During ML discovery, a non-AP MLD discovers the various wireless links available by the AP MLD through its various affiliated APs. It then builds a set of candidate setup links associating affiliated APs with affiliated non-AP stations, from the discovered links (affiliated APs). During ML setup, the non-AP MLD indicates the requested set of candidate setup links to the AP MLD, which accepts or not it.

In case of refusal by the AP MLD, the non-AP MLD has to perform new ML setup procedures with new sets of candidate setup links until the set is accepted by the AP MLD.

This is not a satisfactory situation because the multiple ML setup procedures unnecessarily occupy the wireless medium and further delay the ML communications between the AP MLD and the non-AP MLD. Improved registration procedure is thus desired.

### SUMMARY OF INVENTION

The inventors have found various alternative solutions to this particular problem.

Embodiments of the invention provide a communication method in a wireless network, comprising at an access point, AP, multi-link device, MLD, having multiple affiliated APs:
sending, by a reporting affiliated AP to one or more non-AP MLDs, a management frame advertising profiles of reported affiliated APs,
wherein the management frame categorizes the profiles of the reported affiliated APs.

Correspondingly, a communication method in a wireless network, comprises at a non-access point, non-AP, multi-link device, MLD, having multiple affiliated non-AP stations:
receiving, from a reporting affiliated AP of an AP MLD, a management frame advertising profiles of reported affiliated APs of the AP MLD, wherein the management frame categorizes the profiles of the reported affiliated APs,
selecting reported affiliated APs based on the advertised categorization of the profiles, and
requesting, to the AP MLD, setup links with the selected reported affiliated APs.

Thanks to the advertised categorization or classification of the affiliated APs forming the AP MLD, the AP can provide indication or recommendation on which affiliated APs should be preferably used for the multiple links. The non-AP MLDs can in turn request setup links that are more likely to be accepted by the AP MLD, hence reducing risks of association refusal and then reducing bandwidth waste.

Optional features of these embodiments of the invention are defined in the appended claims. Some of these features are explained here below with reference to a method, while they can be transposed into device features.

In embodiments, the management frame advertises the profiles of the reported affiliated APs using a list of profiles, wherein the list first lists profiles categorized in a first group and then lists profiles categorized in a second group, wherein the management frame signals the number of profiles categorized in one of the groups. A higher number of groups is possible, successively declared in the list.

In some embodiments, a profile categorized in the second group is defined with inheritance from a profile categorized in the first group. Signaling costs may thus be reduced.

In some embodiments, the profiles categorized in the first group are profiles of reported affiliated APs operating on separate frequency bands.

In embodiments, a profile categorized in the second group is a secondary profile alternative to a primary profile of the first group, the primary and secondary profiles being profiles of reported affiliated APs operating on the same frequency band, e.g. 2.4 GHZ, 5 GHZ and 6 GHZ bands.

In some embodiments, a score is signaled in the management frame for each profile of the reported affiliated APs, hence categorizing the advertised profiles.

In some embodiments, the profiles of the reported affiliated APs are advertised in a ML element that is additional, in the management frame, to an advertising of a profile of the reporting affiliated AP.

In some embodiments, a profile of an affiliated AP includes network information of a basic service set, BSS, managed by the affiliated AP. Network information is defined below and may comprise capabilities and operation parameters of the BSS or affiliated AP.

In some embodiments, the management frame is one of a beacon frame periodically sent by the reporting affiliated AP and a ML probe response frame sent by the reporting affiliated AP in response to a ML probe request frame received from a non-AP MLD. The management frame categorizing the profiles of the affiliated APs therefore take place during the ML Discovery procedure.

In some embodiments from non-AP MLD perspective, selecting reported affiliated APs includes traversing the advertised profiles from high-rank categorized profiles to low-rank categorized profiles.

In other embodiments, selecting reported affiliated APs includes selecting reported affiliated APs operating on separate frequency bands.

Other independent embodiments of the invention seeking to improve the registration procedure concern a communication method in a wireless network, comprising at a non-access point, non-AP, multi-link device, MLD, having multiple affiliated non-AP stations:
sending, by a reporting affiliated non-AP station to an AP MLD, a ML association request frame indicating links with affiliated APs of the AP MLD that are requested for ML setup,
wherein the ML association request frame advertises candidate setup links and one or more candidate backup links as alternatives to one or more candidate setup links.

Correspondingly, a communication method in a wireless network, comprises at an access point, AP, multi-link device, MLD, having multiple affiliated APs:
receiving, from a reporting affiliated non-AP station of a non-AP MLD, a ML association request frame indicating links with affiliated APs of the AP MLD that are requested for ML setup, wherein the ML association request frame advertises candidate setup links and one or more candidate backup links as alternatives to one or more candidate setup links,
determining acceptable links for ML setup from the candidate setup and backup links, and
sending, to the reporting affiliated non-AP station, a ML association response frame indicating the links that are accepted for ML setup.

Thanks to the additional candidate backup links, the AP which may be inclined to refuse a requested candidate setup link can then find a fallback link (one of the so-called candidate backup links), hence reducing risks of refusal and then reducing bandwidth waste.

Optional features of these embodiments of the invention are defined in the appended claims. Some of these features are explained here below with reference to a method, while they can be transposed into device features.

In some embodiments, the ML association request frame signals the number of candidate setup links and advertises the candidate setup and backup links using a list of links first listing the candidate setup links.

In other embodiments, a candidate backup link is an alternative to a candidate setup link when their affiliated APs operate on the same frequency band (from amongst 2.4 GHZ, 5 GHz, 6 GHZ). For example, the candidate setup and backup links have the same affiliated AP but different affiliated non-AP stations of the non-AP MLD. In a variant, the candidate setup and backup links have different affiliated APs but the same affiliated non-AP station of the non-AP MLD. In another variant, the candidate setup and backup links have different affiliated APs and different affiliated non-AP stations of the non-AP MLD. These variants may be combined from pair of candidate setup and backup links to the other.

In some embodiments, a candidate setup or backup link is defined between an affiliated AP of the AP MLD and an affiliated non-AP station of the non-AP MLD.

In some embodiments, the candidate setup links are links with affiliated APs operating on separate frequency bands.

In some embodiments, the candidate setup and backup links are advertised in a ML element that is additional, in the ML association request frame, to a requested setup link defined between the reporting affiliated non-AP station and a reporting affiliated AP addressee of the ML association request frame.

In other embodiments, the ML association request frame includes a declaration of simultaneous or non-simultaneous transmit and receive, STR or NSTR, operation capabilities of the non-AP MLD for each pair of affiliated APs of the AP MLD.

In yet other embodiments, the method further comprises receiving, by the reporting affiliated non-AP station from the AP MLD, a ML association response frame indicating links that are accepted for ML setup, wherein accepted links include one candidate backup link.

In some embodiments, the ML association response frame includes a Basic variant ML Element that includes a plurality of Per-STA profile subelements, each Per-STA profile subelement defining one of the accepted links by indicating a Link ID uniquely identifying the affiliated AP of the accepted link and by indicating a profile of an affiliated non-AP station of the accepted link.

In some embodiments from AP MLD perspective, the accepted links in the ML association response frame include one candidate backup link.

Yet other independent embodiments of the invention seeking to improve the registration procedure concern a communication method in a wireless network, comprising at a non-access point, non-AP, multi-link device, MLD, having multiple affiliated non-AP stations:
sending, by a reporting affiliated non-AP station to an AP MLD, a ML association request frame indicating links with affiliated APs of the AP MLD that are requested for ML setup,
receiving, by the reporting affiliated non-AP station from the AP MLD, a ML association response frame indicating links that are accepted for ML setup, wherein the accepted links are a subset of the requested links.

Correspondingly, a communication method in a wireless network, comprises at an access point, AP, multi-link device, MLD, having multiple affiliated APs:
receiving, from a reporting affiliated non-AP station of a non-AP MLD, a ML association request frame indicating links with affiliated APs of the AP MLD that are requested for ML setup, and
sending, to the reporting affiliated non-AP station, a ML association response frame indicating links that are accepted for ML setup, wherein the accepted links are a subset of the requested links.

Thanks to the ability of the AP MLD to accept a subset of the requested setup links, the AP MLD no longer refuse the association as soon as one requested setup link cannot be accepted. Hence risks of association refusal are reduced and bandwidth waste is in turn also reduced.

In some embodiments, the method at the AP MLD further comprises determining acceptable links for ML setup from the requested setup links.

In some embodiments, the method further comprises exchanging frames between the non-AP MLD and the AP MLD over the multiple accepted links.

In other embodiments, the ML association request frame indicates a first requested link between the reporting affiliated non-AP station and a reporting affiliated AP addressee of the ML association request frame and additional requested links (in a separate ML element) between reported affiliated non-AP stations and reported affiliated APs of the AP MLD, wherein ML association response frame accepts the first requested link and a subset of the additional requested links with reported affiliated APs.

Correlatively, the invention also provides a wireless communication device comprising at least one microprocessor configured for carrying out the steps of any of the above methods. The wireless communication device is thus either a non-AP MLD or an AP MLD.

Another aspect of the invention relates to a non-transitory computer-readable medium storing a program which, when executed by a microprocessor or computer system in a wireless device, causes the wireless device to perform any method as defined above.

At least parts of the methods according to the invention may be computer implemented. Accordingly, the present invention may take the form of an entirely hardware embodiment, an entirely software embodiment (including firmware, resident software, micro-code, etc.) or an embodiment combining software and hardware aspects that may all generally be referred to herein as a “circuit”, “module” or “system”. Furthermore, the present invention may take the form of a computer program product embodied in any tangible medium of expression having computer usable program code embodied in the medium.

Since the present invention can be implemented in software, the present invention can be embodied as computer readable code for provision to a programmable apparatus on any suitable carrier medium. A tangible carrier medium may comprise a storage medium such as a hard disk drive, a magnetic tape device or a solid-state memory device and the like. A transient carrier medium may include a signal such as an electrical signal, an electronic signal, an optical signal, an acoustic signal, a magnetic signal or an electromagnetic signal, e.g. a microwave or RF signal.

### BRIEF DESCRIPTION OF THE DRAWINGS

Embodiments of the invention will now be described, by way of example only, and with reference to the following drawings in which:

FIG. 1 illustrates a typical 802.11 network environment involving ML transmissions;

FIG. 2 schematically illustrates an exemplary sequence of management frames for operating the ML discovery and ML setup procedure when establishing a Multi-Link transmission;

FIG. 3 illustrates a Multi-Link Element included in ML Discovery management frames as specified by the current version v0.4 of IEEE 802.11be amendment standard;

FIG. 4 illustrates a first variant of the ML Element used during ML Discovery procedure and categorizing the Per-STA profiles of reported affiliated APs, according to embodiments of the invention;

FIG. 5 illustrates the first variant of the ML Element during a ML Discovery procedure in the scenario of FIG. 1;

FIG. 6 illustrates a second variant of the ML Element used during ML Discovery procedure and categorizing the Per-STA profiles of reported affiliated APs, according to embodiments of the invention;

FIG. 7 illustrates the second variant of the ML Element during a ML Discovery procedure in the scenario of FIG. 1;

FIG. 8 illustrates a Multi-Link Element included in a ML Association Request frame as specified by the current version v0.4 of IEEE 802.11be amendment standard;

FIG. 9 illustrates an alternative Multi Link Element for a ML Association Request frame according to embodiments of the invention providing candidate backup links;

FIG. 10 illustrates this alternative ML Association Request frame in the scenario of FIG. 1;

FIG. 11 illustrates the multiple links resulting from an implementation of the candidate backup links;

FIG. 12 illustrates ML Association Response frames in the scenarios of FIGS. 1 and 11;

FIG. 13 illustrates, using a flowchart, general steps at a non-AP MLD;

FIG. 14 illustrates, using a flowchart, general steps at AP MLD; and

FIG. 15 shows a schematic representation of a wireless communication device in accordance with embodiments of the present invention.

### DETAILED DESCRIPTION OF EMBODIMENTS

The techniques described herein may be used for various broadband wireless communication systems, including communication systems that are based on an orthogonal multiplexing scheme. Examples of such communication systems include Spatial Division Multiple Access (SDMA) system, Time Division Multiple Access (TDMA) system, Orthogonal Frequency Division Multiple Access (OFDMA) system, and Single-Carrier Frequency Division Multiple Access (SC-FDMA) system. A SDMA system may utilize sufficiently different directions to simultaneously transmit data belonging to multiple user terminals, i.e. wireless devices or stations. A TDMA system may allow multiple user terminals to share the same frequency channel by dividing the transmission signal into different time slots or resource units, each time slot being assigned to different user terminal. An OFDMA system utilizes orthogonal frequency division multiplexing (OFDM), which is a modulation technique that partitions the overall system bandwidth into multiple orthogonal sub-carriers or resource units. These sub-carriers may also be called tones, bins, etc. With OFDM, each sub-carrier may be independently modulated with data. A SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers.

The teachings herein may be incorporated into (e.g., implemented within or performed by) a variety of apparatuses (e.g., stations). In some aspects, a wireless device or station implemented in accordance with the teachings herein may comprise an access point (so-called AP) or not (so-called non-AP station or STA).

While the examples are described in the context of WiFi® networks, the invention may be used in any type of wireless networks like, for example, mobile phone cellular networks that implement very similar mechanisms.

An AP may comprise, be implemented as, or known as a Node B, Radio Network Controller (“RNC”), evolved Node B (eNB), 5G Next generation base station (gNB), Base Station Controller (“BSC”), Base Transceiver Station (“BTS”), Base Station (“BS”), Transceiver Function (“TF”), Radio Router, Radio Transceiver, Basic Service Set (“BSS”), Extended Service Set (“ESS”), Radio Base Station (“RBS”), or some other terminology.

A non-AP station may comprise, be implemented as, or known as a subscriber station, a subscriber unit, a mobile station (MS), a remote station, a remote terminal, a user terminal (UT), a user agent, a user device, user equipment (UE), a user station, or some other terminology. In some implementations, a STA may comprise a cellular telephone, a cordless telephone, a Session Initiation Protocol (“SIP”) phone, a wireless local loop (“WLL”) station, a personal digital assistant (“PDA”), a handheld device having wireless connection capability, or some other suitable processing device connected to a wireless modem. Accordingly, one or more aspects taught herein may be incorporated into a phone (e.g., a cellular phone or smart phone), a computer (e.g., a laptop), a tablet, a portable communication device, a portable computing device (e.g., a personal data assistant), an entertainment device (e.g., a music or video device, or a satellite radio), a global positioning system (GPS) device, or any other suitable device that is configured to communicate via a wireless or wired medium. In some aspects, the non-AP station may be a wireless node. Such wireless node may provide, for example, connectivity for or to a network (e.g., a wide area network such as the Internet or a cellular network) via a wired or wireless communication link.

An AP manages a set of stations that together organize their accesses to the wireless medium for communication purposes. The stations (including the AP) form a service set, here below referred to as basic service set, BSS (although other terminology can be used). A same physical station acting as an access point may manage two or more BSS (and thus corresponding WLANs): each BSS is thus uniquely identified by a specific basic service set identification, BSSID and managed by a separate virtual AP implemented in the physical AP.

The 802.11 family of standards define various media access control (MAC) mechanisms to drive access to the wireless medium.

The current discussions in the task group 802.11be, as illustrated by draft IEEE P802.11be/D0.4 of March 2021, introduce the multi-link operation (MLO) when it comes to MAC layer operation. The MLO allows multi-link devices to establish or setup multiple links and operate them simultaneously.

A multi-link device (MLD) is a logical entity and has more than one affiliated station (STA) and has a single medium access control (MAC) service access point (SAP) to logical link control (LLC), which includes one MAC data service. An access point multi-link device (or AP MLD then corresponds to a MLD where each station (STA) affiliated with the MLD is an AP, hence referred to as “affiliated AP”. A non-access point multi-link device (or non-AP MLD) corresponds to a MLD where each station (STA) affiliated with the MLD is a non-AP STA, referred to as “affiliated non-AP station”. Depending on the literature, “multilink device”, “ML device” (MLD), “multilink logical entity”, “ML logical entity” (MLE), “multilink set” and “ML set” are synonyms to designate the same type of ML device.

Multiple affiliated non-AP stations of a non-AP MLD can then setup communication links with multiple affiliated APs of an AP MLD, hence forming a multi-link channel. Preferably, the links established for MLDs are considered as fully independent, meaning that the channel access procedure (to the communication medium) and the communication are performed independently on each link. Hence, different links may have different data rates (e.g. due to different bandwidths, number of antennas, etc.) and may be used to communicate different types of information (each over a specific link).

A communication link or “link” thus corresponds to a given channel (e.g. 20 MHZ, 40 MHz, and so on) in a given frequency band (e.g. 2.4 GHZ, 5 GHZ, 6 GHZ) between an AP affiliated with the AP MLD and a non-AP STA affiliated with the non-AP MLD.

The affiliated APs and non-AP stations operate on their respective channels in accordance with one or more of the IEEE 802.11 standards (a/b/g/n/ac/ad/af/ah/aj/ay/ax/be) or other wireless communication standards.

Thanks to the multi-link aggregation, traffic associated with a single MLD can be transmitted across multiple parallel communication links, thereby increasing network capacity and maximizing utilization of available resources.

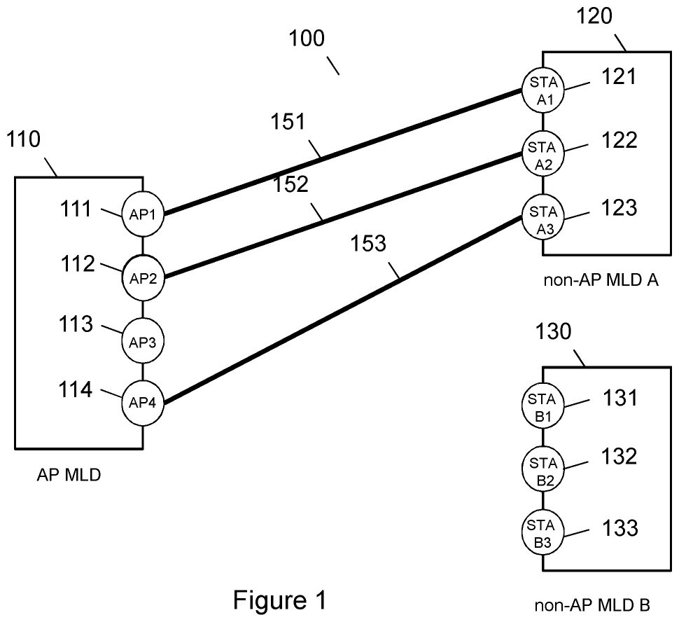

FIG. 1 illustrates a typical 802.11 network environment involving ML transmissions in which the present invention may be implemented.

Wireless communication network 100 involves an AP MLD 110 and two non-AP MLDs 120 and 130. Of course, another number of non-AP MLDs registering to the AP MLD 110 and then exchanging frames with it may be contemplated.

AP MLD 110 has multiple affiliated APs, four affiliated APs 111, 112, 113 and 114 (also referenced AP1, AP2, AP3, AP4 respectively) in the exemplary Figure, each of which behaves as an 802.11 AP over its operating channel within one frequency band. Known 802.11 frequency bands include the 2.4 GHz band, the 5 GHz band and the 6 GHz band. Of course, other frequency bands may be used in replacement or in addition to these three bands.

Non-AP MLDs 120, 130 have multiple affiliated non-AP stations, each of which behaves as an 802.11 non-AP station in a BSS (managed by an affiliated AP 111, 112, 113, 114) to which it registers. Preferably but not necessarily, non-AP MLDs have less affiliated non-AP stations than the number of APs affiliated with the AP MLD 110. In the exemplary Figure, three non-AP STAs 121, 122 and 123 (also referenced A1, A2, A3 respectively) are affiliated with non-AP MLD 120 and three non-AP STAs 131, 132 and 133 (also referenced B1, B2, B3 respectively) are also affiliated with non-AP MLD 130.

For illustrative purpose, AP 111 is set to operate on channel 10 corresponding to an operating 20 MHz channel in the 2.4 GHz frequency band, AP 112 is set to operate on channel 36-40 corresponding to an operating 40 MHz channel in the 5 GHz frequency band, AP 113 is set to operate on channel 149-153 corresponding to an operating 40 MHz channel in the 5 GHz frequency band too, and AP 114 is set to operate on channel 301 corresponding to an operating 160 MHz channel in the 6 GHz frequency band. In this example, the affiliate stations operate on various frequency bands.

Each affiliated AP offers a link towards the AP MLD 110 to the affiliated non-AP stations. Hence the links for each non-AP MLD can be merely identified with the identifiers of the respective affiliated APs. In this context, each of the affiliated APs 111-114 can be identified by an identifier referred to as “link ID”. The link ID of each affiliated AP is unique and does not change during the lifetime of the AP MLD. AP MLD may assigne the link ID to its affiliated APs by incrementing the ID from 0 (for the first affiliated AP). Of course, other wording such as “AP ID” could be used in a variant.

To perform multi-link communications, each non-AP MLD 120, 130 has to discover, authenticate, associate and set up multiple links with the AP MLD 110, each link being established between an affiliated AP of the AP MLD 110 and an affiliated non-AP station of the non-AP MLD. Each link enables individual channel access and frame exchanges between the non-AP MLD and the AP MLD based on the supported capabilities exchanged during association.

The present invention focuses on the discovery phase, referred below to as ML discovery procedure, and the multi-link setup phase (or association phase), referred below to as ML setup procedure.

The ML discovery procedure allows the non-AP MLD to discover the wireless communication network 100, i.e. the various links to the AP MLD offered by the multiple affiliated APs. The ML discovery procedure thus seeks to advertise the various affiliated APs of the AP MLD, together with the respective network information.

The network information of an affiliated AP may include all or part of capabilities and operation parameters.

Typically, the network information contains at least the operating class, the channel number and the BSSID of the affiliated AP. It may also include more complete information elements relative to its capabilities and operational parameters. The capability elements may indicate inter alia one or more of high-throughput (HT) capabilities, very high-throughput (VHT) capabilities, high efficiency (HE) capabilities, HE 6 GHZ Band capabilities, or extremely high-throughput (EHT) capabilities. The operating elements may indicate inter alia one or more of HT operation parameters, VHT operation parameters, HE operation parameters, EHT operation parameters, enhanced distributed channel access (EDCA) parameters, multi-user (MU) EDCA parameters, uplink (UL) orthogonal frequency division multiple access (OFDMA) random access (UORA) parameters, target wait time (TWT) parameters, fast initial link setup (FILS) parameters, or spatial reuse (SR) parameters.

Once a non-AP MLD has discovered the wireless communication network 100 through the ML discovery procedure and after an MLD authentication procedure, the ML setup procedure allows it to select a set of candidate setup links between its own affiliated non-AP stations and some of the discovered affiliated APs and to request the AP MLD 110 to set up these links, which may be accepted or refused by the AP MLD.

If accepted, the non-AP MLD is provided with an Association Identifier (AID) by the AP MLD, which AID is used by the affiliated non-APs of the non-AP MLD to wirelessly communicate over the multiple links (communication channels) with their corresponding affiliated APs.

For illustrative purpose, in wireless communication network 100, three candidate setup links have been requested by non-AP MLD 120 to AP MLD 110 and have been accepted by AP MLD 110: a first link 151 between affiliated AP 111 (AP1) and affiliated non-AP STA 121 (A1), a second link 152 between affiliated AP 112 (AP2) and affiliated non-AP STA 122 (A2), and a third link 153 between affiliated AP 114 (AP4) and affiliated non-AP STA 123 (A3).

A refusal to set up the requested candidate setup links means that ML setup procedure, possibly the whole registration procedure, needs to be reiterated with a new set of candidate setup links until an approval is received. The time to establish the set of candidate setup links would be uncertain and could be very important in case of multiple refused proposals.

For illustrative purpose, in wireless communication network 100, three candidate setup links have been requested by non-AP MLD 130 to AP MLD 110 and have been refused by AP MLD 110 for example because AP MLD 110 considers that the candidate setup link between affiliated AP 112 (AP2) and affiliated non-AP STA 132 (B2) is currently not available

The present invention seeks to reduce risks of refusal by the AP MLD, in order to reduce the time for the non-AP MLD to register to the AP MLD 110, hence to reduce bandwidth waste.

Various alternative solutions to this particular problem have been found.

Some regard the categorization or classification, such as a hierarchy, of the APs affiliated with the AP MLD 110 in order to promote or favor those for which the AP MLD is more likely to accept candidate setup links. The AP MLD can thus signal its recommendations (categorization) to the non-AP MLDs during the ML discovery procedure. The management frames, such as beacon frames or probe response frames involved during the ML discovery procedure, categorize the profiles of the reported affiliated APs for example into groups.

Some others regard the indication by the non-AP MLD of one or more candidate backup links as alternatives to one or more of the candidate setup links during the ML setup procedure. Should the AP MLD be likely to refuse one of the candidate setup links, it has now the opportunity to select an alternative backup link to avoid the refusal and then reach an agreement on the multi-link to be set up.

Others also regard the ability of the AP MLD to accept a subset of the requested setup links, and not only the whole set of candidate setup links. The ML association response frame sent by the AP MLD during the ML setup phase now indicates links that are accepted for ML setup, where the accepted links are a subset of the requested links.

Each of these solutions can be implemented individually. They can also be combined, all together or some of them together. Indeed, each of them individually reduces risks of association refusal by the AP MLD.

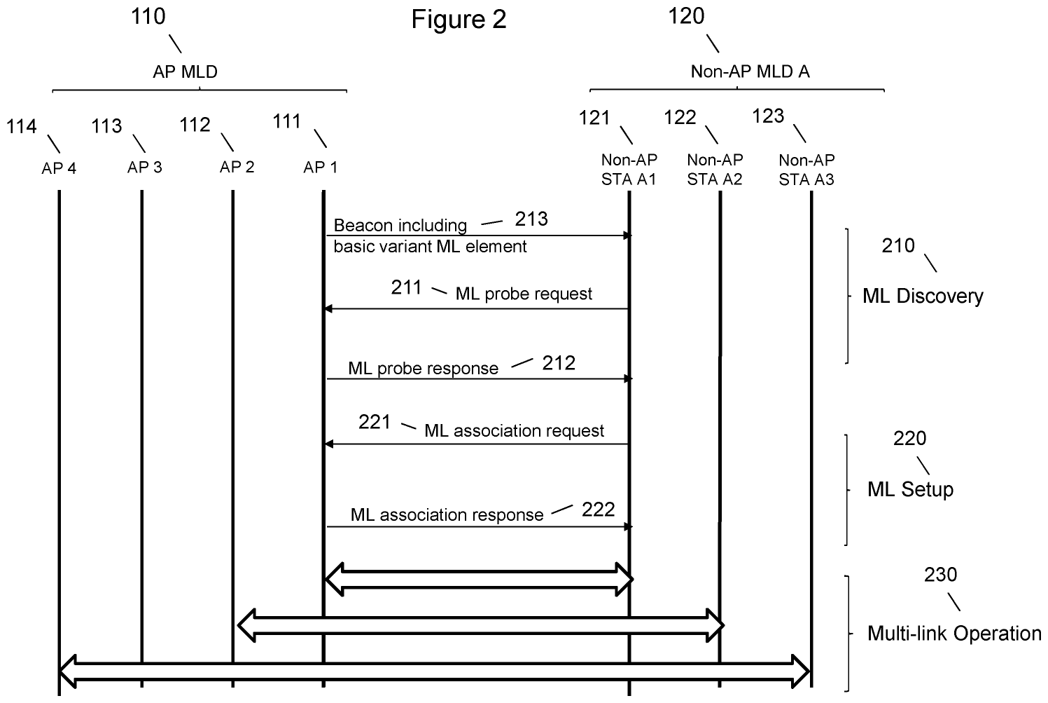

FIG. 2 schematically illustrates an exemplary sequence of management frames for operating the ML discovery and ML setup procedure when establishing a ML transmission between AP MLD 110 and non-AP MLD 120.

In order to establish a ML transmission, the non-AP MLD initiates the ML discovery procedure 210 to retrieve the available links proposed by AP MLD 110. This can be done through passive and/or active scanning operations on frequency channels in one or more of the frequency bands (typically 2.4 GHZ, 5 GHZ and 6 GHz bands).

The passive scanning consists in listening ML beacon frames 213 sent periodically by an affiliated AP of AP MLD 110 (AP1 in the example) on its operation channel. Each or part or all of the affiliated APs can periodically send ML beacon frames on its operating channel.

The active scanning consists in an exchange of management frames between the non-AP MLD and the AP MLD. In particular, the non-AP MLD transmits (through its affiliated non-AP stations) a ML probe request frame 211 on each channel to be scanned by its affiliated non-AP stations 121, 122 and 123 and listens for the reception of ML probe response frames 212 from the AP MLD (by the respective affiliate APs on its operating channel). A ML probe request frame 211 can be transmitted by each affiliated non-AP station over the operating channel on which it is configured.

The ML probe request frame 211 allows the affiliated non-AP station to request an affiliated AP to include, in addition to its network information, the complete or partial set of capabilities and operation elements (i.e. network information) of other APs affiliated with the same AP MLD.

The affiliated stations involved in the management frame exchange are referred to as “reporting” affiliated stations, while the other affiliated stations of the same MLDs are referred to as “reported” affiliated stations.

Therefore, in the example of FIG. 2, reporting affiliated non-AP station 121 (A1) sends the ML Probe Request frame 211 to reporting affiliated AP 111 (AP1) to obtain the network information of AP1 as well as the network information of the reported affiliated APs 112, 113, 114 (AP2, AP3, AP4).

Although the example shows AP1 111 and station A1 121 as reporting affiliated stations, any other pair of affiliated stations operating on the same operating channel (e.g. AP4 with A3) can be used as reporting affiliated stations.

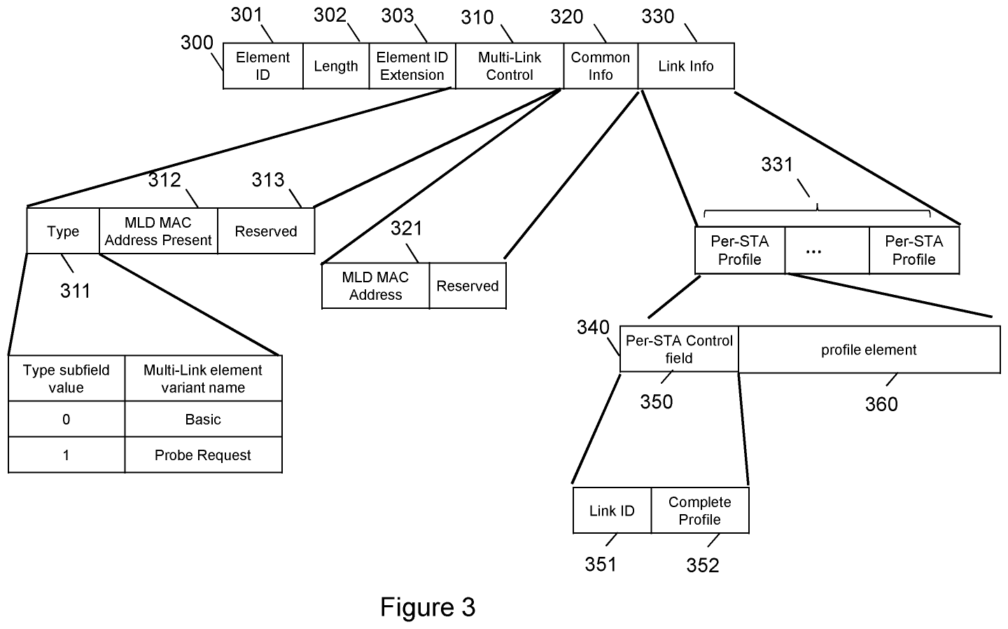

The ML Probe Request frame 211 is a Probe Request frame as defined in 802.11ax (for example IEEE P802.11ax/D8.0 of October 2020) augmented with a Probe Request variant Multi-Link element 300 as illustrated in FIG. 3 and defined in IEEE P802.11be/D0.4.

The 802.11ax fields of the Probe Request frame are used in a conventional way, for instance to request the network information of the solicited (hence “reporting”, here AP1 111) affiliated AP of AP MLD 110. Furthermore, the Address 1 field of MAC header of frame 211 is set to the broadcast address and the Address 3 field is set to the BSSID of the affiliated AP, or the Address 1 field is set to the BSSID of an affiliated AP's BSS. This affiliated AP is the reporting affiliated AP.

The Multi-Link element 300 includes Element ID field 301, Length field 302 (enabling to know the presence or not of the optional fields as well as the number of Per-STA profiles in field 330), Element ID Extension field 303, Multi-Link Control field 310, optional Common Info field 320 and optional Link Info field 330.

Multi-Link Control field 310 includes a Type subfield 311 and a MLD MAC Address Present subfield 313. The Type subfield 311 is set to value 1 in order to signal the Multi-Link element 300 is a Probe Request variant ML element.

Subfield 312 is set to 1 to indicate Common Info field 320 includes MLD MAC Address subfield 321 when the MAC address of the AP MLD 110 is known. Otherwise it is set to 0 and no Common Info field 320 is provided. MLD MAC Address subfield 321, if any, is set to the MAC address of the AP MLD 110.

Optional Link Info field 330 is used by reporting non-AP station A1 to indicate which affiliated APs are targeted and which corresponding network information elements are requested.

A (reported) AP affiliated with the same AP MLD as the (reporting) affiliated AP identified in the Address 1 or Address 3 field of the ML Probe Request frame 211 is targeted if one of the following conditions is met:
the Multi-Link element in the ML Probe Request frame 211 does not include any per-STA profile 340 in Link Info field 330. Hence, no Link Info field 330 is provided (or it is empty) if all the network information elements of all the reported affiliated APs of the AP MLD are requested,
the link ID of the targeted (reported) affiliated AP is equal to the value in the Link ID field 351 in Per-STA Control subfield 350 of one of the Per-STA Profile subelement 340. Hence, one or more Per-STA profiles 340 are listed in the Link Info field 330, each indicating one targeted affiliated AP through Link ID subfield 351 (set to the link ID of the targeted affiliated AP).

In case where the targeted affiliated APs are explicitly listed through Per-STA Profile subelements 340, Complete Profile subfield 352 indicates whether all the network information elements (“Complete Profile”) are requested or only partial information (“Partial Profile”) is requested. For example, subfield 352 is set to 1 to request a complete profile while it is set to 0 to request a partial profile. In case of requested partial profile, the requested network information elements can be explicitly indicated in Profile Element subfield 360. Hence, the requested network information elements can vary from one targeted affiliated AP to the other.

Note that fields additional to those shown in the Figure may be provided in the ML Element 300. They are not shown for conciseness purposes.

In the scenario of FIG. 1 for example, a ML Probe Request 211 is sent by (reporting) affiliated non-AP STA 121 (A1) including a Probe Request variant ML element 300 with Address 3 field of the MAC header set to the BSSID of (reporting) affiliated AP 111 (AP1). Type subfield 311 of Multi-link control field 310 is set to value 1 (Probe Request variant), MLD MAC address subfield 321 is set to the MAC address of AP MLD 110 and Link Info field 330 is let empty (all network information for all affiliated APs are requested). Similarly, a ML Probe Request 211 is sent also by (reporting) affiliated non-AP STA 131 (B1) including a Probe Request variant ML element 300 with Address 3 field of the MAC header set to the BSSID of (reporting) affiliated AP 111 (AP1). Of course, the ML Probe Request 211 from non-AP MLD 130 could be sent to a different affiliated AP than the one addressed by non-AP MLD 120. Type subfield 311 in the ML element 300 of frame 211 from non-AP MLD 130 is also set to value 1, MLD MAC address field 321 is also set to the MAC address of the AP MLD 110 and Link Info field 330 is also let empty.

Upon receiving the ML Probe Request 211, AP MLD 110 shall respond with a ML Probe Response 212 which carries the requested network information for its targeted affiliated APs as indicated in the ML Probe Request 211.

The ML Probe Response 212 is a Probe Response frame as defined in 802.11ax (for example IEEE P802.11ax/D8.0 of October 2020) augmented with a Basic variant Multi-Link element 300 as illustrated in FIG. 3 and defined in IEEE P802.11be/D0.4. The Basic variant Multi-Link element 300 carries complete or partial per-STA profile(s), based on the soliciting request, for each of the requested AP(s) affiliated with AP MLD 110.

The 802.11ax fields of the Probe Response frame are used in a conventional way, for instance to carry the network information of the reporting (here AP1 111) affiliated AP of AP MLD 110. Furthermore, the Address 1 field of the MAC header may be set to the broadcast address.

In the Basic variant Multi-Link element 300 for the ML Probe Response 212, Type subfield 311 is set to value 0 (“Basic variant”) and MLD MAC address subfield 321 is set to the MAC address of the AP MLD 110.

Link Info field 330 comprises a set 331 of one or more Per-STA Profile subelements 340, one for each targeted (reported) affiliated AP of AP MLD 110. Hence, the Per-STA profiles of the reported affiliated APs are advertised in a ML element 300 that is additional, in the frame, to an advertising of a profile of the reporting affiliated AP (made in the 802.11ax conventional fields).

Each per-STA profile 340 identifies the targeted affiliated AP through Link ID subfield 351 set to the Link ID of the targeted affiliated AP. Complete Profile subfield 352 is set to 1 when the ML Probe Request 211 requests complete profiles. On the other hand, Complete Profile subfield 352 is set to 0 when the ML Probe Request 211 requests partial profiles. Profile Element subfield 360 then carries all the requested network information (either complete or partial set of information elements as specified in the ML Probe Request 211) for the targeted affiliated AP indicated in Link ID subfield 352.

In the scenario of FIG. 1 for example, upon receiving ML Probe Request 211 sent by non-AP station 121 (A1) affiliated with non-AP MLD 120, affiliated AP 111 (AP1) affiliated with AP MLD 110 transmits ML Probe Response 212 addressed to reporting affiliated non-AP station 121 (A1). The 802.11ax fields of ML Probe Response 212 carries the network information elements of reporting affiliated AP 111 (AP1). ML Probe Response 212 also includes a Basic variant ML element 300 in which Type subfield 311 is set to value 0, MLD MAC address subfield 321 is set to the MAC address of AP MLD 110 and Link Info field 330 contains the set of Per-STA profiles of reported affiliated APs 112 (AP2), 113 (AP3) and 114 (AP4), each Per-STA profile including all the network information elements of the corresponding reported affiliated AP.

Similarly, upon receiving ML Probe Request 211 sent by non-AP station 131 (B1) affiliated with non-AP MLD 130, affiliated AP 111 (AP1) affiliated with AP MLD 110 transmits ML Probe Response 212 addressed to reporting affiliated non-AP station 131 (B1). The 802.11ax fields of ML Probe Response 212 to affiliated non-AP station B1 carries the network information elements of reporting affiliated AP 111 (AP1). ML Probe Response 212 also includes a Basic variant ML element 300 in which Type subfield 311 is set to value 0, MLD MAC address subfield 321 is set to the MAC address of AP MLD 110 and Link Info field 330 contains the set of Per-STA profiles of reported affiliated APs 112 (AP2), 113 (AP3) and 114 (AP4), each Per-STA profile including all the network information elements of the corresponding reported affiliated AP.

Thanks to ML Probe Responses 212 advertising the profiled of the affiliated APs, non-AP MLD 120 and 130 are aware (discovery) of the various affiliated APs available at AP MLD 110 and of their network information. In a conventional manner, this information helps non-AP MLDs to choose the BSSs their affiliated non-AP stations should register to (i.e. should join).

The passive scanning through ML beacon frames 213 provides the same information. In this respect, ML beacon frames sent by the affiliated AP can carry the same ML element (FIG. 3) additional to convention 802.11ax fields conveying network information of the reporting affiliated AP. Preferably, ML beacon frame 213 provides all the network information (Complete Profile) for all the affiliated APs. Therefore, the set 331 of Per-STA Profile subelements 340 include one Per-STA profile subelement per each reported affiliated AP, in which Complete Profile subfield 352 is set to 1 and all network information is provided in corresponding Profile Element subfield 360.

In the scenario of FIG. 1 for example, any (reporting) affiliated AP (let say 111-AP1) affiliated with AP MLD 110 broadcast ML Beacon frame 213 on its operating channel. The 802.11ax fields of ML Beacon frame 213 carries the network information elements of reporting affiliated AP (111-AP1), i.e. of the BSS managed by the reporting affiliated AP on its operating channel. ML Beacon frame 213 also includes a Basic variant ML element 300 in which Type subfield 311 is set to value 0, MLD MAC address subfield 321 is set to the MAC address of AP MLD 110 and Link Info field 330 contains the set of Per-STA profiles for all the other (reported) APs affiliated with AP MLD 110, i.e. AP2 112, AP3 113 and AP4 114. Each Per-STA profile includes all the network information elements of the corresponding reported affiliated AP.

In some embodiments of the invention, such management frames (ML Probe Response 212 and/or ML Beacon frame 213) sent by AP MLD 110 are augmented to provide additional recommendations to the non-AP MLDs with a view of performing a better selection of the BSSs (affiliated APs) to which register.

Such recommendations may be performed by signalling a categorization of the Per-STA profiles of the reported affiliated APs. Indeed, the categorization may indicate for instance preferential affiliated APs compared to others.

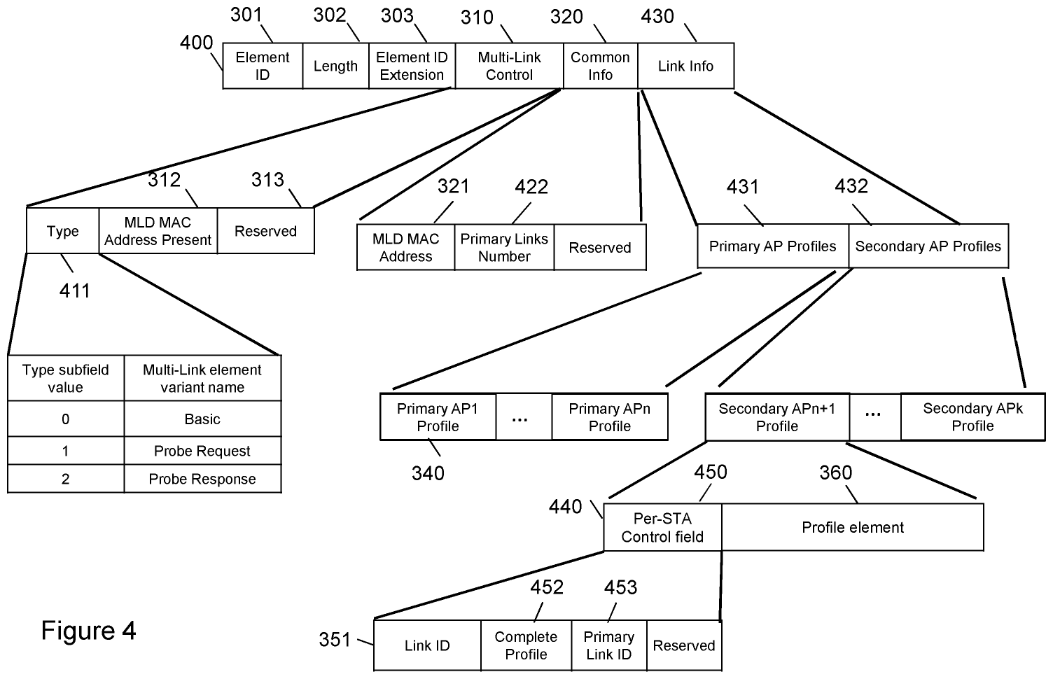

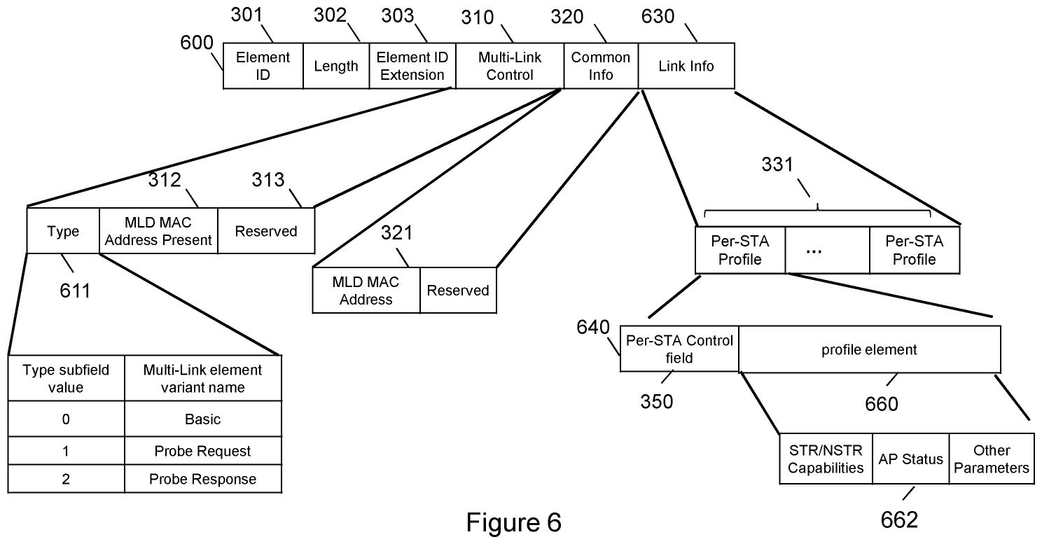

FIGS. 4 and 6 illustrate two variants of ML Element 300 categorizing the reported affiliated APs during ML Discovery procedure. The fields and subfields of the two variants that are similar to those of FIG. 3 are labelled with the same numeral reference.

In one embodiment illustrated by FIG. 4, the management frame advertises the profiles of the reported affiliated APs using a list of profiles, for example in Link Info field 430. The list first lists profiles categorized in a first group 331 and then lists profiles categorized in a second group 332. The management frame also signals the number 422 of profiles categorized in one of the groups, preferably in the first group.

Although the Figure shows two categorization groups (categories or classes), the Per-STA profiles may be categorized in a higher number of groups, thereby creating a hierarchy or prioritization of profiles with a higher number of levels (than two).

ML Element 400 used in the management frame may be a Basic variant ML element, i.e. with Type subfield 411 set to 0. In a variant allowing the affiliated APs to choose between two possible formats for the management frame (either the one of FIG. 3 or the one of FIG. 4), a new variant, e.g. Probe Response variant, of the ML element may be defined. For example, Type subfield 411 is set to 2.

For illustrative purposes, the classification is used by AP MLD 110 to provide a first category of affiliated APs considered as primary in which elements within are referred to as primary links and a second category of affiliated APs considered as secondary in which elements within are referred to as secondary links. The primary links (to primary affiliated APs) are links privileged by AP MLD 110 compared to secondary links (to secondary affiliated APs); it would be preferable by non-AP MLD 120, 130 to select candidate links to set up firstly among the primary links and then select secondary links only when necessary.

The categorization of the Per-STA profiles of the reported affiliated APs thus gives recommendations to the non-AP MLDs for helping/assisting them on their selection of the candidate setup links.

To signal the categorization, Primary Links Number subfield 422 is provided in

Common Info field 320 that indicates the number N of Per-STA profiles in the Link Info fields that are classified in the first category. This information allows the non-AP MLD to correctly parse the set 431 of high-ranked Per-STA profiles and on the other hand, the set 432 of low-ranked Per-STA profiles.

When more than two categories are provided, Common Info field 320 may include one or more other subfield to provide the number of Per-STA profiles for each category less one.

Link Info field 430 thus contains all the Per-Sta Profile subelements corresponding to the requested (reported) affiliated APs. The set 431 of Per-STA profiles corresponding to the primary links (primary affiliated APs) is listed firstly and corresponds to the N first elements of Link Info field 430 as specified in Primary Links Number field 422. Each Per-STA profile for a primary link may be a Per-STA profile 340 as described above with reference to FIG. 3. Notably, each Per-STA Profile 340 is identified by Link ID subfield 351 corresponding to the Link ID of the targeted affiliated AP.

Preferably, the primary Per-STA profiles categorized in the first group (primary group) are profiles of reported affiliated APs operating on separate frequency bands. In other words, the primary links correspond to operating channels on separate frequency bands. The AP MLD can thus select only one primary link (affiliated AP) for each frequency band, the others links (affiliated APs) being considered as secondary links.

For example, the reporting affiliated AP (reporting link) operating on a first frequency band (e.g. 2.4 GHZ) is described in the 802.11ax fields of the management frame and the ML element 400 includes two primary Per-STA profiles in set 431 corresponding to one reported affiliated AP operating on a different second frequency band (e.g. 5 GHZ) and one reported affiliated AP operating on a different third frequency band (e.g. 6 GHZ).

The set 432 of one or more Per-STA profiles corresponding to the secondary link or links (secondary affiliated APs) is listed afterwards, from the N+1th element of Link Info field 430. Each Per-STA profile for a secondary link may be a Per-STA profile 340 as described above with reference to FIG. 3. Preferably, a profile categorized in the second group (Per-STA profile for a secondary link) is a secondary profile alternative to a primary profile of the first group (Per-STA profile for a primary link), the primary and secondary profiles being profiles of reported affiliated APs operating on the same frequency band, e.g. 2.4 GHZ, 5 GHz and 6 GHz bands. In other words, the profile of a secondary link is an alternative to a profile of a primary link operating on the same frequency band as the secondary link.

For example, the set 432 may include a first secondary Per-STA profile corresponding to a reported affiliated AP operating on the second frequency band (e.g. 5 GHZ) and a second secondary Per-STA profile corresponding to a reported affiliated AP operating on the third frequency band (e.g. 6 GHZ). The two secondary Per-STA profiles are then alternatives to the two primary Per-STA profiles mentioned above, respectively.

It is often that affiliated APs of the same AP MLD that are operating on the same frequency band are configured with quite similar capabilities and operation parameters (network information). The profile element of a secondary link may thus be inherited from the profile element of the primary link operating on the same frequency band. Therefore, in some embodiments seeking to reduce signalling costs, a profile categorized in the second group (Per-STA profile for a secondary link) may be defined with inheritance from a profile categorized in the first group (Per-STA profile for a primary link, for instance operating on the same frequency band).

The secondary Per-STA profiles 440 of set 432 may thus be different from the Per-STA profiles 340 of FIG. 3. As shown in FIG. 4, in embodiments, Per-STA Control subfield 450 of a secondary Per-STA profile 440 includes Primary Link ID subfield 453 to indicate from which primary Per-STA profile 340 the current secondary Per-STA profile 440 inherits. Profile element 360 may then carry the differences between the network information of the two concerned (reported) affiliated APs operating on the same frequency band (primary and secondary ones).

In embodiments, Complete Profile subfield 452 may be used to signal whether inheritance is used, i.e. whether Primary Link ID subfield 453 is provided. For example, Complete Profile subfield 452 is set to 2 to indicate inheritance from the primary profile (indicated in subfield 453) for the current secondary profile.

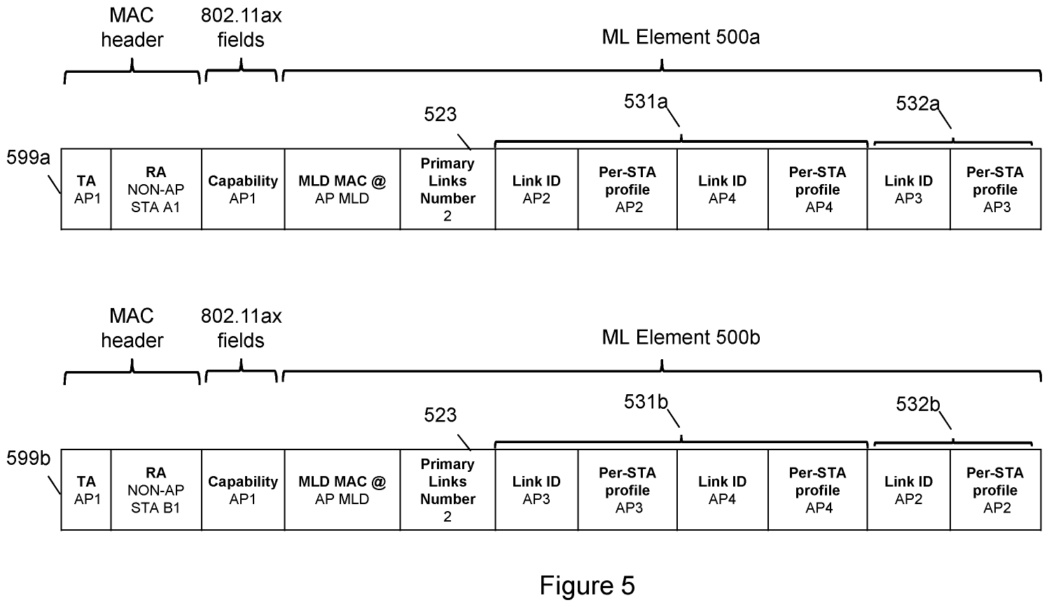

In the scenario of FIG. 1 for example, ML Probe Responses 212 from AP MLD 110 to non-AP MLDs 120, 130 are as schematically shown in FIG. 5 (useless fields are not shown). The same frame is used as a ML Beacon frame except that the RA field (see below) is set to a broadcast address.

Frame 599a is the ML Probe Response sent by reporting affiliated AP 111 (AP1) in response to a ML Probe Request 211 from affiliated non-AP station 121 (A1) of non-AP MLD 120. MAC header indicates the reporting affiliated AP (TA field set to the MAC address of AP1) and the destination reporting affiliated non-AP station (RA field set to the MAC address of A1). 802.11ax fields includes the network information of the reporting affiliated AP (AP1). ML Element 500a (corresponding to 400) contains Primary Links Number subfield 523 (corresponding to subfield 423) set to 2, indicating two primary Per-STA profiles are defined, the other Per-STA profiles in the Link Info field 430 being secondary ones. The set of primary Profiles 531a (corresponding to 431) contains the Per-STA profiles of affiliated APs corresponding to reported affiliated AP 112 (AP2) and reported affiliated AP 114 (AP4). The set of secondary Profiles 532a (corresponding to 432) contains the Per-STA profile of reported affiliated AP 113 (AP3). For example, AP3 and AP2 operate on the same frequency band. Secondary Profile of AP3 may thus inherit from the primary Profile of AP2.

Similarly, frame 599b is the ML Probe Response sent by reporting affiliated AP 111 (AP1) in response to a ML Probe Request 211 from affiliated non-AP station 131 (B1) of non-AP MLD 120. ML Element 500b contains Primary Links Number subfield 523 set to 2, indicating two primary Per-STA profiles are defined, the other Per-STA profiles in the Link Info field 430 being secondary ones. The set of primary Profiles 531b contains the Per-STA profiles of affiliated APs corresponding to reported affiliated AP 113 (AP3) and reported affiliated AP 114 (AP4). The set of secondary Profiles 532b contains the Per-STA profile of reported affiliated AP 112 (AP2).

In an embodiment alternative to FIG. 4 and as shown in FIG. 6, a categorizing score is signaled in the management frame for each Per-STA profile of the reported affiliated APS, hence categorizing the advertised profiles. The explications above for the embodiment of FIG. 4 apply for this embodiment except that instead of listing the Per-STA profiles in the order of the categories, the present embodiment provides a specific AP status subfield 662 in each reported Per-STA profile 640 of the Link Info field 630 to indicate a score (hence a category—each score defining a category).

In the Figure, AP status subfield 662 is provided in Profile element subfield 660 of the Per-STA profile 640. In a variant, AP status subfield 662 may be provided in Per-STA Control subfield 350 as a new subfield.

In embodiments, AP status subfield 662 is a one-bit field with a value set to 1 to indicate that the corresponding reported affiliated AP (hence link) is recommended by AP MLD 110 and would be certainly accepted if the non-AP MLD selects it as candidate setup link. On the other hand, one-bit AP status subfield 662 is set to 0 to indicate that the corresponding reported affiliated AP is available but not recommended by AP MLD 110 according to the current conditions of the channel (as link usage, interferences) and would be certainly refused if the non-AP MLD selects it as candidate setup link.

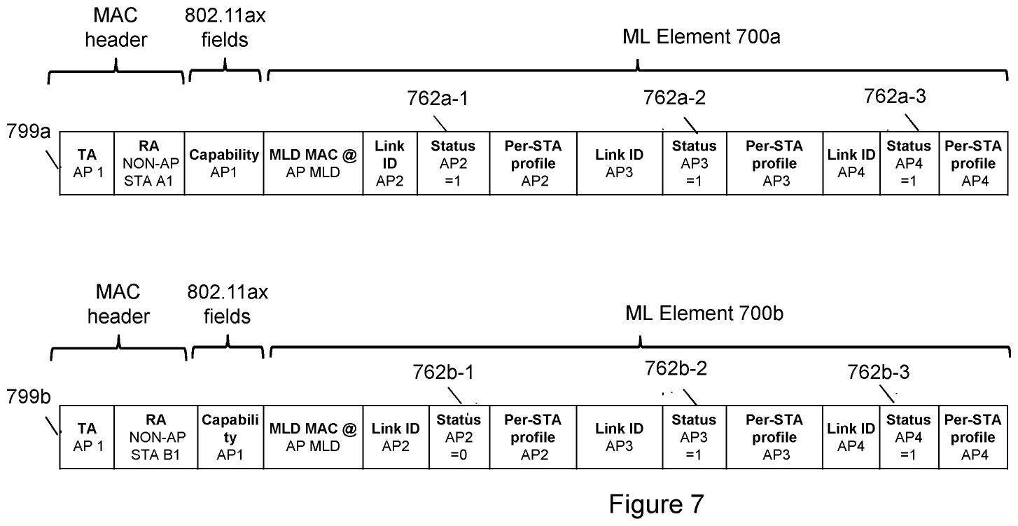

In variants, AP status subfield 662 may be a multiple-bit field to allow more than two values. Multiple categories can then be defined. Also, a hierarchy between the Per-STA profiles of the reported affiliated APs can be signaled by the AP MLD to recommend some of them. In the scenario of FIG. 1 for example, ML Probe Responses 212 from AP MLD 110 to non-AP MLDs 120, 130 are as schematically shown in FIG. 7 (useless fields are not shown). The same frame is used as a ML Beacon frame except that the RA field (see below) is set to a broadcast address.

Frame 799a is the ML Probe Response sent by reporting affiliated AP 111 (AP1) in response to a ML Probe Request 211 from affiliated non-AP station 121 (A1) of non-AP MLD 120. Each Per-STA profile (in the ML element 700a) describing a reported affiliated AP includes AP status subfield 762a: field 762a-1 corresponding to reported affiliated AP 112 (AP2) Per-STA Profile element is set to 1 to declare it as recommended, field 762a-2 corresponding to reported affiliated AP 113 (AP3) Per-STA Profile element is set to 1 to declare it as recommended and field 762a-3 corresponding to reported affiliated AP 114 (AP4) Per-STA Profile element is set to 1 to declare it as recommended.

Similarly, frame 799b is the ML Probe Response sent by reporting affiliated AP 111 (AP1) in response to a ML Probe Request 211 from affiliated non-AP station 131 (B1) of non-AP MLD 120. Field 762b-1 corresponding to reported affiliated AP 112 (AP2) Per-STA Profile element is set to 0 to declare it as not-recommended, field 762b-2 corresponding to reported affiliated AP 113 (AP3) Per-STA Profile element is set to 1 to declare it as recommended and field 762b-3 corresponding to reported affiliated AP 114 (AP4) Per-STA Profile element is set to 1 to declare it as recommended. It means that the affiliated AP 112 (AP2) is not recommended for non-AP MLD 130 and would be refused if it is selected as candidate setup link by non-AP MLD 130.

Back to FIG. 2, the ML Discovery procedure provided non-AP MLD 120 with information on the available affiliated APs of AP MLD 110. Next, non-AP MLD 120 initiates a ML setup procedure 220 to setup the links to be involved in the ML transmission to establish, referred to as “setup links”. The ML setup procedure consists in an exchange of ML Association Request and ML Association Response frames between the reporting non-AP station (A1 121 in the example) affiliated with non-AP MLD 120 and the reporting AP (AP1 111 in the example) affiliated with AP MLD 110.

To prepare the ML Association Request 221, the reporting affiliated non-AP station A1 has to determine which candidate setup links should be requested to AP MLD 110 (through reporting affiliated AP AP1). This is done by analysing the network information of the various affiliated APs advertised during the ML Discovery procedure 210.

For example, the reporting affiliated non-AP station A1 may traverse the affiliated AP's Per-STA profiles from high-rank categorized profiles to low-rank categorized profiles. Also, A1 may select affiliated APs operating on separate frequency bands to build candidate setup links on separate frequency bands. The reported affiliated APs for the candidate setup links can thus be selected based on the advertised categorization of the profiles, when categorization is provided in the management frames of the ML Discovery procedure.

Any policy to choose which affiliated non-AP station of the non-AP MLD to use with which affiliated AP can be used to build a candidate setup link. In practice, the affiliated non-AP station and AP of a candidate setup link operate on the same frequency band. For illustrative purposes only, the non-AP MLD may take into account radio constraints of its affiliated non-AP stations but also seek to maximize the number of STR link pairs as described below.

Once the candidate setup links are known, the non-AP MLD requests AP MLD 110 to setup those links. This is done by sending, by any (reporting) affiliated non-AP station of the non-AP MLD, the ML Association Request frame indicating the candidate setup links with affiliated APs of the AP MLD that are requested for ML setup.

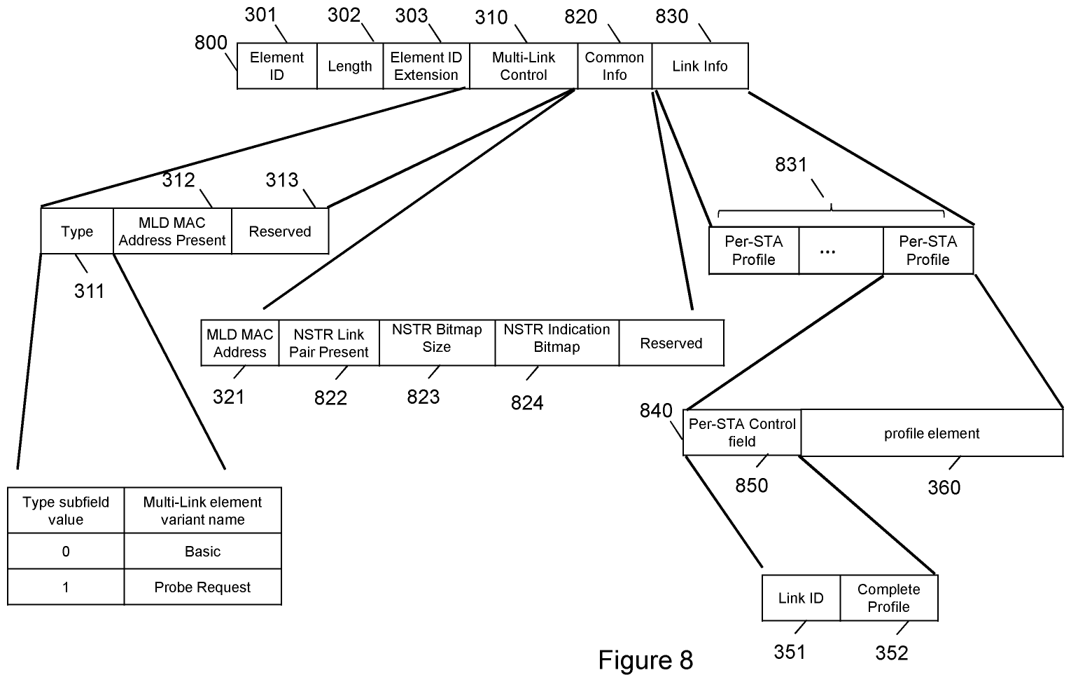

ML Association Request frame 221 is an Association Request frame as defined in 802.11ax (for example IEEE P802.11ax/D8.0 of October 2020) augmented with a Basic variant Multi-Link element 800 as illustrated in FIG. 8 and defined in IEEE P802.11be/D0.4. The fields and subfields of the ML element 800 that are similar to those of FIG. 3 are labelled with the same numeral reference.

The 802.11ax fields of the Association Request frame are used in a conventional way, for instance to request the association of the reporting affiliated non-AP station (here A1 121) with the addressee reporting affiliated AP (here AP1 111). This defines a requested setup link defined between the reporting affiliated non-AP station and a reporting affiliated AP addressee of the ML Association Request frame.

MAC header of frame 221 sets the transmitting address TA to the MAC address of the reporting affiliated non-AP station A1 and the destination address RA to the MAC address of the destination affiliated AP AP1.

In the Basic variant Multi-Link element 800, Type subfield 311 is set to value 0 and MLD MAC address field 321 is set to the MAC address of the requesting non-AP MLD (here MLD 120).

Link Info field 830 indicates the candidate setup links that are requested for setup. Link Info field 830 is made of a set 831 of Per-STA Profile subelements 840, each Per-STA Profile element 840 defining one of the requested candidate setup links.

A candidate setup link is defined between an affiliated AP of the AP MLD and an affiliated non-AP station of the non-AP MLD. Link ID subfield 351 of the Per-STA Profile is set to the Link ID of the affiliated AP corresponding to the candidate setup link concerned. Complete Profile subfield 352 is set to 1 and Profile Element subfield 360 includes all the network information elements of the affiliated non-AP station corresponding to the candidate setup link concerned.

In embodiments, the ML association request frame includes a declaration of simultaneous or non-simultaneous transmit and receive, STR or NSTR, operation capabilities of the non-AP MLD for multiple pairs, preferably each pair, of affiliated APs of AP MLD 110. Compared to IEEE P802.11be/D0.4, the STR/NSTR capabilities for all the affiliated APs and not only for the pairs of those affiliated APs involved in the candidate setup links are defined. In the example of FIG. 8, proposed fields to declare NSTR capabilities of pairs of Link IDs (i.e. affiliated APs) candidate setup links are provided in Common Info field 820.

NSTR Link Pair Present subfield 822 is set to 1 if there is at least one pair of Link IDs (affiliated APs) for which the non-AP MLD is NSTR, i.e. not able to simultaneously transmit to and receive from the two affiliated APs of the pair. It is set to 0 otherwise, in which case the following subfields 823, 824 are not provided.

In case at least one pair of affiliated APs is NSTR, NSTR Bitmap Size subfield 823 is set to 1 if the length of the corresponding NSTR Indication Bitmap subfield 824 is two octets x two octets (e.g. if there are more than eight affiliated APs in AP MLD 110) or is set to 0 if the length of the corresponding NSTR Indication Bitmap field 824 is one octet x one octet (e.g. if there are eight or less affiliated APs). Each bit Bij of the 8×8-bit or 16×16-bit bitmap is used to indicate the NSTR or STR capability of the non-AP MLD when communicating with the affiliated APs “i” and “j” (hence j≠i). Preferably, “i” and “j” correspond to the Link ID of the affiliated APs. Bij is set to 1 if the non-AP MLD is NSTR when communicating with affiliated AP “j” and affiliated AP “i”. Otherwise (STR), Bij is set to 0.

In the scenario of FIG. 1, a ML Association Request 221 is sent by affiliated non-AP station 121 (A1) including a Basic variant multi-link element (Type subfield 311 set to 0) with MLD MAC address field 321 set to the MAC address of non-AP MLD 120. Link Info field 830 contains a set of two Per-STA Profiles 840 corresponding to candidate setup links: a first candidate setup link corresponding to a communication link between affiliated AP 112 (AP2) and affiliated non-AP station 122 (A2) and a second candidate setup link between affiliated AP 114 (AP4) and affiliated non-AP station 123 (A3). Consequently, a first Per-STA profile 340 corresponding to the first candidate setup link is set with Link ID subfield 351 set to the Link ID of affiliated AP 112 (AP2) and with Profile element subfield 360 carrying the complete network information elements of affiliated non-AP STA 122 (A2). A second Per-STA profile 340 corresponding to the second candidate setup link is set with Link ID 351 subfield set to the Link ID of affiliated AP 114 (AP4) and with Profile element subfield 360 carrying all the network information elements of affiliated non-AP STA 123 (A3).

A similar ML Association Request 221 may be sent by affiliated non-AP station 131 (B1) of non-AP MLD 130, which defines two candidate setup links: a first candidate setup link corresponding to a communication link between affiliated AP 112 (AP2) and affiliated non-AP STA 132 (B2), and a second candidate setup link between affiliated AP 114 (AP4) and affiliated non-AP STA 133 (B3).

In some embodiments of the invention, the ML Association Request frame 221 is augmented to provide alternative links in case AP MLD 110 is liable to refuse some requested candidate setup links. Alternative links are defined below as candidate backup links. These embodiments thus provide that the ML association request frame 221 advertises candidate setup links and one or more candidate backup links as alternatives to one or more candidate setup links.

By reporting this information, AP MLD 110 has now the possibility to choose amongst the set of candidate backup links if it refuses a candidate setup link because it knows that the requesting non-AP MLD will accept the new alternative proposal from the candidate backup links.

As mentioned above, the candidate setup links are preferably links over separate frequency bands. A candidate backup link can thus be an alternative to a candidate setup link on the same frequency band, i.e. when their corresponding affiliated APs operate on the same frequency band. It means the candidate setup and backup links may have the same affiliated AP but different affiliated non-AP stations of the non-AP MLD, or may have different affiliated APs but the same affiliated non-AP station of the non-AP MLD, or may have different affiliated APs and different affiliated non-AP stations of the non-AP MLD.

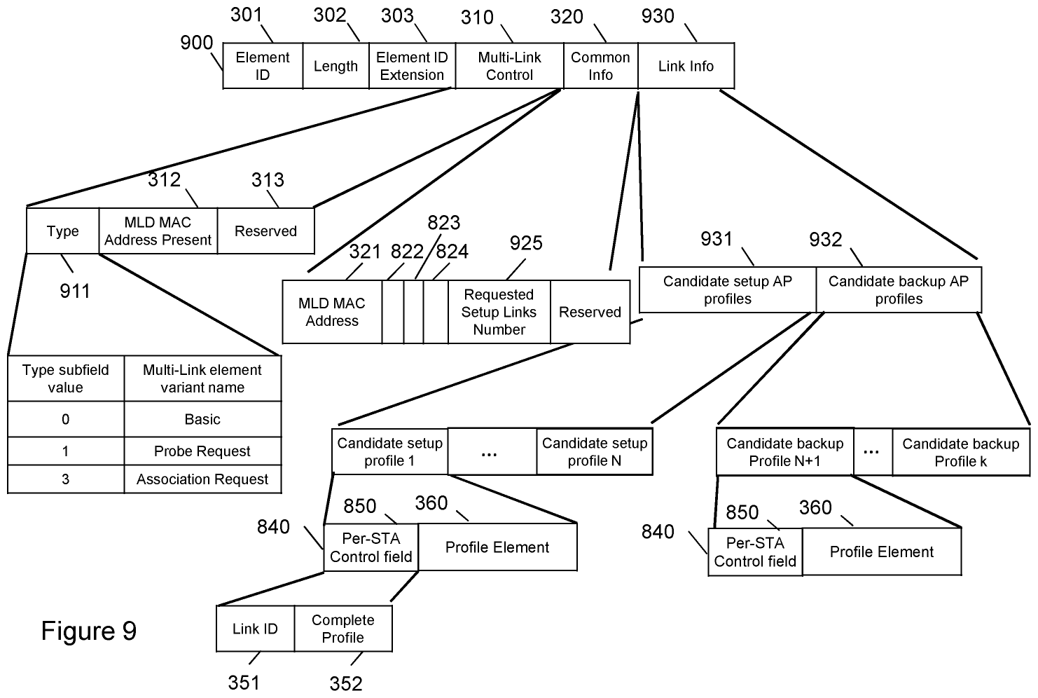

An implementation of these embodiments is shown in FIG. 9 where the ML association request frame 221 advertises the candidate setup and backup links using a list of links first listing the candidate setup links and then signals the number of candidate setup links in order to correctly identify the candidate setup links from the candidate backup links.

Link Info field 930 of ML Element 900 included in ML Association Request 221 thus firstly contains a set 931 of Per-STA profiles 840 corresponding to the requested candidate setup links and contains afterwards a set 932 of Per-STA profiles 840 corresponding to the proposed candidate backup links. The size of set 931 is defined by Requested Setup Links Number subfield 925 in Common Info field 320, which contains the number N of Per-STA profiles (i.e. of candidate setup links) forming set 931. Set 932 thus starts from the N+1-th Per-STA profile in the Link Info field 930.

ML Element 900 may be a Basic variant ML element, i.e. with Type subfield 911 set to 0. In a variant allowing the affiliated non-AP stations to choose between two possible formats for the ML Association Request frame (either the one of FIG. 8 or the one of FIG. 9), a new variant, e.g. Association Request variant, of the ML element may be defined. For example, Type subfield 911 is set to 3.

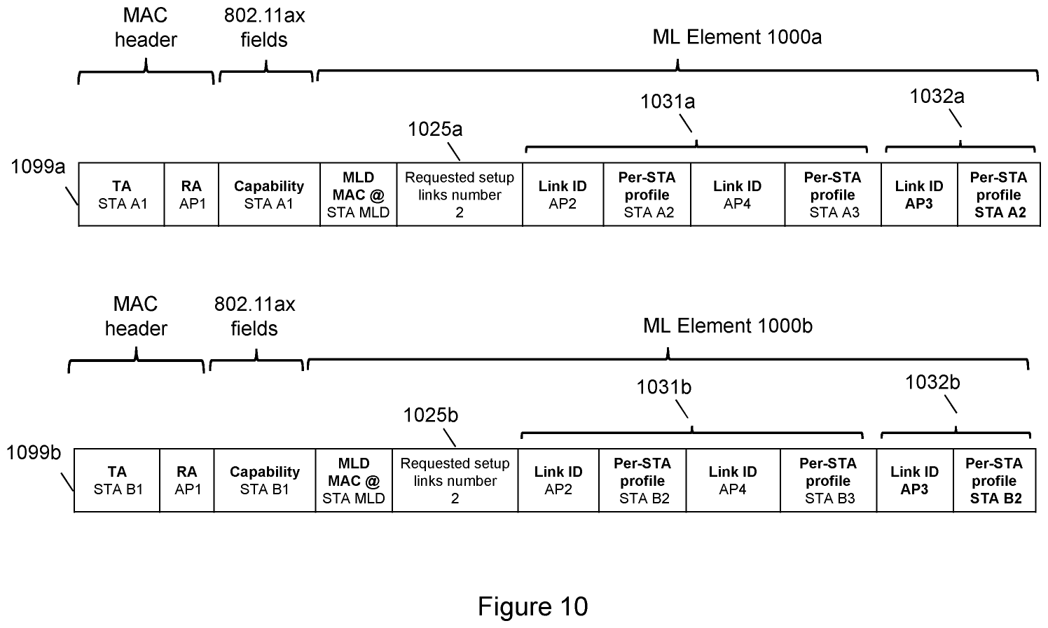

In the scenario of FIG. 1, ML Association Requests 221 from affiliated non-APs A1 and B1 to AP MLD 110 (affiliated AP AP1) are as schematically shown in FIG. 10 (useless fields are not shown).

Frame 1099a is the ML Association Request sent by reporting affiliated non-AP 121 (A1—specified in TA field of the MAC header) to affiliated AP 111 (AP1—specified in RA field of the MAC header). 802.11ax fields are used to request the setup of the link between A1 and AP1 by indicating the network information of the reporting affiliated non-AP station (A1).

ML Element 1000a (corresponding to 900) contains Requested Setup Links Number subfield 1025a (corresponding to subfield 925) set to 2, indicating there are two requested candidate setup links (in addition to the link between A1 and AP1), the other Per-STA profiles in the Link Info field 930 defining the requested candidate backup links. The set 1031a of requested candidate setup links (corresponding to 931) contains a first Per-STA profile defining the candidate setup link between reported affiliated AP 112 (AP2) and reported affiliated non-AP station 122 (A2) and a second Per-STA profile defining the candidate setup link between reported affiliated AP 114 (AP4) and reported affiliated non-AP station 123 (A3). In addition, one candidate backup link is proposed in the set 1032a of requested candidate backup links (corresponding to 932). It contains a Per-STA profile defining the candidate backup link between reported affiliated AP 113 (AP3) and reported affiliated non-AP station 122 (A2). It is thus understood that this candidate backup link is an alternative to the first candidate setup link above (between AP2 and A2) because it operated on the same frequency band (the one of A2).

Similarly, frame 1099b is the ML Association Request sent by reporting affiliated non-AP 131 (B1) to affiliated AP 111 (AP1). In addition to the requested link between AP1 and B1 (in the 802.11ax fields), ML Element 1000b contains two requested candidate setup links (Requested Setup Links Number subfield 1025a set to 2): a first Per-STA profile defining the candidate setup link between reported affiliated AP 112 (AP2) and reported affiliated non-AP station 132 (B2) and a second Per-STA profile defining the candidate setup link between reported affiliated AP 114 (AP4) and reported affiliated non-AP station 133 (B3). ML Element 1000b also contains a one candidate backup link in set 1032a: the candidate backup link between reported affiliated AP 113 (AP3) and reported affiliated non-AP station 132 (B2). It is thus understood that this candidate backup link is an alternative to the first candidate setup link above (between AP2 and B2) because it operated on the same frequency band (the one of B2).

As it can be easily understood from the scenario of FIG. 1, as the candidate setup link (AP2, B2) will be refused by AP MLD 110, the proposed candidate backup links now allows AP MLD 110 not to only refuse all the requested candidate setup links but to allow candidate links by replacing the refused candidate setup link (AP2, B2) by the candidate backup link (AP3, B2).

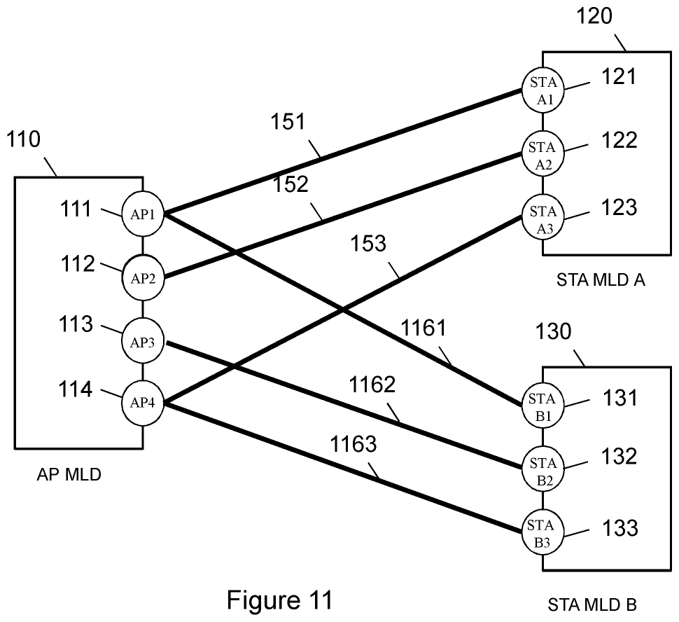

It turns, as shown in FIG. 11, that links can be now accepted by AP MLD 110 for non-AP MLD 130: a first link 1161 between affiliated AP 111 (AP1) and affiliated non-AP STA 131 (B1), a second link 1162 between affiliated AP 113 (AP3) and affiliated non-AP STA 132 (B2)—this was the candidate backup link as proposed by non-AP MLD 130, and a third link 1163 between affiliated AP 114 (AP4) and affiliated non-AP STA 133 (B3).

Signalling the acceptance is made by AP MLD 110 by sending ML Association Response 222 responsive to the reception of ML Association Request 221. As mentioned above, AP MLD 110 determines acceptable links for ML setup from the candidate setup and backup (if any) links. Thanks to the above embodiments, the accepted links in the ML association response frame may include one (or more) candidate backup link.

ML Association Response 222 indicates the requested links that are accepted for setup.

ML Association Response 222 is an Association Response frame as defined in 802.11ax (for example IEEE P802.11ax/D8.0 of October 2020) augmented with a Basic variant Multi-Link element similar to the one illustrated in FIG. 3 and defined in IEEE P802.11be/D0.4.

The 802.11ax fields of the Association Request frame are used in a conventional way, to accept the association of the reporting affiliated non-AP station (here A1 121) with the addressee reporting affiliated AP (here AP1 111). The Association Request frame provides on this occasion an Association Identifier (AID) to the requesting non-AP MLD 120 for use in the wireless communications with the affiliated APs of AP MLD 110.

In the Basic variant Multi-Link element of the Association Response frame, Type subfield 311 is set to 0 and MLD MAC address subfield 321 is set to the MAC address of AP MLD 110. Link Info subfield 330 contains a set of Per-STA Profiles corresponding to the candidate links accepted for setup, each Per-STA Profile 340 thus corresponding to an accepted candidate link (i.e. to an affiliated AP). For a given accepted candidate (setup or backup) link, Link ID subfield 351 is set to the Link ID of the affiliated AP of the accepted setup link, Complete Profile subfield 352 is set to 1 and Profile Element 360 includes the complete network information of the affiliated non-AP station of the accepted candidate link.

In other words, the ML association response frame includes a Basic variant ML Element (300) that includes including a plurality of Per-STA profile subelements 340, each Per-STA profile subelement defining one of the accepted links by indicating a Link ID 351 uniquely identifying the affiliated AP of the accepted link and by indicating a profile 360 of an affiliated non-AP station of the accepted link. This allows the non-AP MLD to exactly know which candidate links are accepted.

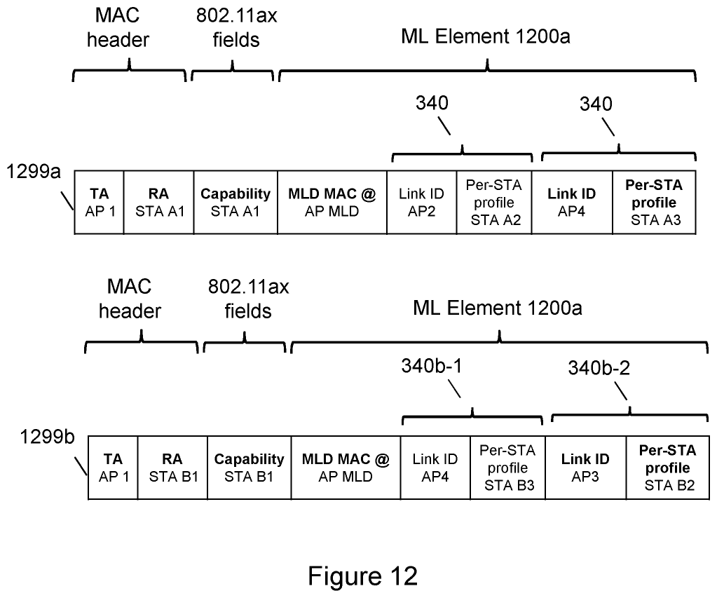

In the scenario of FIG. 1 or 11, ML Association Responses 222 from reporting affiliated AP AP1 to reporting affiliated non-APs A1 and B1 are as schematically shown in FIG. 12 (useless fields are not shown).

Frame 1299a is the ML Association Response sent by the reporting affiliated AP (AP1—specified in TA field of the MAC header) to the reporting affiliated non-AP station (A1—specified in RA field of the MAC header) in response to a previous ML Association Request 221. 802.11ax fields are used to signal acceptance of the requested link between A1 and AP1 by indicating the network information of the reporting affiliated non-AP (A1).

Basic variant ML Element 1200a contains one or multiple Per-STA profiles 340 corresponding to one or multiple accepted links. Type subfield 311 is set to 0 and MLD MAC address subfield 321 is set to the MAC address of AP MLD 110. Link Info field 330 contains the set of Per-STA Profile subelements 340 describing the accepted candidate links to affiliated AP 112 (AP2) and affiliated AP 114 (AP4). A first Per-STA profile 340 corresponding to the first accepted candidate link is set with Link ID field 351 set to the Link ID of AP2 and with Profile element subfield 360 carrying all network information elements of affiliated non-AP station A2. A second per-STA profile 340 corresponding to the second accepted candidate link is set with Link ID subfield 351 set to the Link ID of AP4 and with Profile element subfield 360 carrying all network information elements of affiliated non-AP station A3. In this example, AP MLD 110 has accepted all the requested candidate setup links for non-AP MLD 120.

Similarly, frame 1299b is the ML Association Response sent by the reporting affiliated AP (AP1—specified in TA field of the MAC header) to the reporting affiliated non-AP station (B1—specified in RA field of the MAC header) in response to a previous ML Association Request 221. Further to the acceptance of the requested link between B1 and AP1 (in the 802.11ax fields), Basic variant ML Element 1200b contains one or multiple Per-STA profiles 340 corresponding to one or multiple accepted links.

In some embodiments (with or without the candidate backup links), the AP MLD may decide not to accept all the requested candidate setup links, and accepts only a subset of the requested candidate setup links. The ML Association Response 222 thus indicates links that are accepted for ML setup, wherein the accepted links are a subset of the requested links. This allows for instance, in the scenario of FIG. 1, to setup link 1161 between AP2 and B1 and link 1163 between AP4 and B3 (shown in FIG. 11) even if requested candidate setup link between AP3 and B2 is refused. In that case, only the Per-STA Profile 340b-1 is provided in Basic variant ML Element 1200b.

In other embodiments relying on the candidate backup links, as mentioned above, a (or more) candidate backup link may be accepted by AP MLD 110 in replacement of a refused candidate setup link on the same frequency band. In that case, in addition to Per-STA Profile 340b-1 defining the accepted candidate link between AP4 and B3, a second Per-STA Profile 340b-2 is provided for the accepted candidate backup link between AP3 and B2: Link ID subfield 351 is set to the Link ID of AP3 and Profile element subfield 360 carries all the network information elements of B2.

The ML Association Response may therefore contain, as accepted candidate links, a sub-set of the candidate setup links and a sub-set of the candidate backup links as set in the ML Association Request.

These embodiments correspond to the scenario of FIG. 11 where non-AP MLD 130 can operate ML transmissions over three communications links rather than being deprived of communications links (in the prior art) or being limited to two communications links (1161 and 1163) as in the embodiments discussed above.

Acceptance of a subset of the requested candidate links as well as providing candidate backup links facilitates the establishment of the multiple communication links as the AP has the possibility to accept part of the proposal or to choose an alternative proposition of setup links in case of refusal of the initial set of candidate setup links requested by the non-AP MLD. accepted.

Back to FIG. 2, the ML setup procedure between non-AP MLD 120 and AP MLD 110 terminates with the establishment of one or more setup links. In this situation, non-AP MLD 120 becomes in associated state with AP MLD 110 and is assigned an AID for wireless communication over the multiple links. Non-AP MLD 120 then configures its affiliated non-AP stations for ML transmitting/receiving through the established setup links. Next, the Multi-Link Operation (MLO) 230, i.e. exchange of frames, can take place on the established setup links.

In the scenario of FIG. 1 or 11, non-AP MLD 120 is now associated with AP MLD 110. More precisely, affiliated non-AP station A1 is now associated with AP1 to communicate within the BSS managed by AP1; affiliated non-AP station A2 is now associated with AP2 to communicate within the BSS managed by AP2; and affiliated non-AP station A3 is now associated with AP4 to communicate within the BSS managed by AP4. Non-AP MLD 120 can then operate ML transmissions over three links corresponding to affiliated AP 111, AP 112 and AP 114 of AP MLD 110.

In the scenario of FIG. 11, non-AP MLD 130 is now associated with AP MLD 110. More precisely, affiliated non-AP station B1 is now associated with AP1 to communicate within the BSS managed by AP1; affiliated non-AP station B2 is now associated with AP3 to communicate within the BSS managed by AP3; and affiliated non-AP station B3 is now associated with AP4 to communicate within the BSS managed by AP4. Non-AP MLD 130 can then operate ML transmissions through three links corresponding to affiliated AP 111, AP 113 and AP 114 of AP MLD 110.

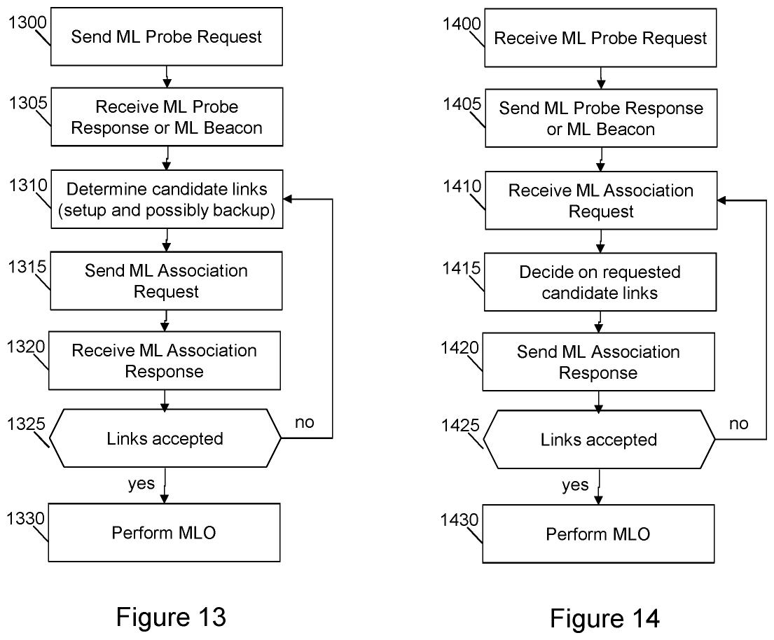

FIG. 13 illustrates, using a flowchart, general steps at a non-AP MLD, such as non-AP MLD 120 or 130. FIG. 14 illustrates, using a flowchart, general steps at AP MLD, such as AP MLD 110. These steps are performed by their reporting affiliated stations.

At optional step 1300 belonging to the ML Discovery procedure, the non-AP MLD sends a ML Probe Request 211 to obtain network information of AP MLD 110, in particular of its affiliated APs. The ML Probe Request is described above, notably with reference to FIG. 3.

Corresponding step at the AP MLD is step 1400 of receiving such ML Probe Request 211.

In response, the AP MLD sends a ML Probe Response 212 with the requested network information for the affiliated APs targeted in the ML Probe Request. In a variant, the AP MLD sends a ML Beacon frame 213. The management frames are described above, notably with reference to FIGS. 3 to 7. This is step 1405.

Corresponding step at the non-AP MLD is step 1305 of receiving such ML Probe Response 212.

Next, at step 1310, the non-AP MLD determines which candidate setup links to request to the AP MLD. The step may also include determining candidate backup links, in some embodiments of the invention.

Next, at step 1315, the non-AP MLD sends a ML Association Request 221 with the requested candidate setup and backup (if any) links. The ML Association Request is described above, notably with reference to FIGS. 8 to 10.

Corresponding step at the AP MLD is step 1410 of receiving such ML Association Request 221.

Next, at step 1415, the AP MLD decides on acceptance of the requested candidate setup links. In embodiments, in case of refusal of a candidate setup link, the AP MLD decides whether a proposed candidate backup link can be accepted. The AP MLD thus builds a list of accepted candidate links. As described above, the list may be a subset of the requested candidate setup links and/or may include one or more candidate backup links.

The list of accepted candidate links is sent by the AP MLD at step 1420 using a ML Association Response 222 as described above, notably with reference to FIG. 12.

Corresponding step at the non-AP MLD is step 1320 of receiving such ML Association Response 222.

In case of acceptance of candidate links for setup (test 1325 at the non-AP MLD, test 1425 at the AP MLD), the MLD configures their affiliated stations and ML transmissions can be performed using the multiple setup links (steps 1330 at the non-AP MLD, step 1430 at the AP MLD).

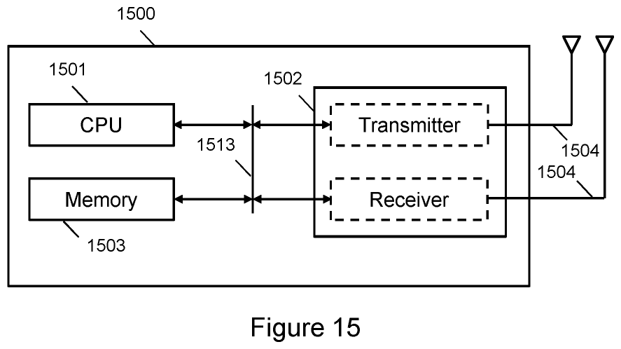

FIG. 15 schematically illustrates a communication device 1500, any of the MLDs discussed above, of a radio network NETW, configured to implement at least one embodiment of the present invention. The communication device 1500 may preferably be a device such as a micro-computer, a workstation or a light portable device. The communication device 1500 comprises a communication bus 1513 to which there are preferably connected:
a central processing unit 1501, such as a processor, denoted CPU;
a memory 1503 for storing an executable code of methods or steps of the methods according to embodiments of the invention as well as the registers adapted to record variables and parameters necessary for implementing the methods; and
at least one communication interface 1502 connected to a wireless communication network, for example a communication network according to one of the IEEE 802.11 family of standards, via transmitting and receiving antennas 1504.

Preferably the communication bus provides communication and interoperability between the various elements included in the communication device 1500 or connected to it. The representation of the bus is not limiting and in particular the central processing unit is operable to communicate instructions to any element of the communication device 1500 directly or by means of another element of the communication device 1500.

The executable code may be stored in a memory that may either be read only, a hard disk or on a removable digital medium such as for example a disk. According to an optional variant, the executable code of the programs can be received by means of the communication network, via the interface 1502, in order to be stored in the memory of the communication device 1500 before being executed.

In an embodiment, the device is a programmable apparatus which uses software to implement embodiments of the invention. However, alternatively, embodiments of the present invention may be implemented, totally or in partially, in hardware (for example, in the form of an Application Specific Integrated Circuit or ASIC).

Although the present invention has been described hereinabove with reference to specific embodiments, the present invention is not limited to the specific embodiments, and modifications will be apparent to a skilled person in the art which lie within the scope of the present invention.

Many further modifications and variations will suggest themselves to those versed in the art upon referring to the foregoing illustrative embodiments, which are given by way of example only and which are not intended to limit the scope of the invention, that being determined solely by the appended claims. In particular the different features from different embodiments may be interchanged, where appropriate.

In the claims, the word “comprising” does not exclude other elements or steps, and the indefinite article “a” or “an” does not exclude a plurality. The mere fact that different features are recited in mutually different dependent claims does not indicate that a combination of these features cannot be advantageously used.

1. A communication method in a wireless network, comprising at a non-access point, non-AP, multi-link device, MLD, having multiple affiliated non-AP stations:
sending, by a reporting affiliated non-AP station to an AP MLD, a ML association request frame indicating links with affiliated APs of the AP MLD that are requested for ML setup,
receiving, by the reporting affiliated non-AP station from the AP MLD, a ML association response frame indicating links that are accepted for ML setup, wherein the accepted links are a subset of the requested links.

2. A communication method in a wireless network, comprising at an access point, AP, multi-link device, MLD, having multiple affiliated APs:
receiving, from a reporting affiliated non-AP station of a non-AP MLD, a ML association request frame indicating links with affiliated APs of the AP MLD that are requested for ML setup, and
sending, to the reporting affiliated non-AP station, a ML association response frame indicating links that are accepted for ML setup, wherein the accepted links are a subset of the requested links.

3. The method of claim 2, further comprising, at the AP MLD, determining acceptable links for ML setup from the requested setup links.

4. The method of claim 1, further comprising exchanging frames between the non-AP MLD and the AP MLD over the multiple accepted links.

5. The method of claim 1, wherein the ML association request frame indicates a first requested link between the reporting affiliated non-AP station and a reporting affiliated AP addressee of the ML association request frame and additional requested links between reported affiliated non-AP stations and reported affiliated APs of the AP MLD, wherein ML association response frame accepts the first requested link and a subset of the additional requested links with reported affiliated APs.

6-29. (canceled)

30. A wireless communication device comprising at least one microprocessor configured for carrying out the method of claim 1.

31. A non-transitory computer-readable medium storing a program which, when executed by a microprocessor or computer system in a wireless device, causes the wireless device to perform the method of claim 1.

32. The method of claim 2, further comprising exchanging frames between the non-AP MLD and the AP MLD over the multiple accepted links.

33. The method of claim 3, further comprising exchanging frames between the non-AP MLD and the AP MLD over the multiple accepted links.

34. The method of claim 2, wherein the ML association request frame indicates a first requested link between the reporting affiliated non-AP station and a reporting affiliated AP addressee of the ML association request frame and additional requested links between reported affiliated non-AP stations and reported affiliated APs of the AP MLD, wherein ML association response frame accepts the first requested link and a subset of the additional requested links with reported affiliated APs.

35. The method of claim 3, wherein the ML association request frame indicates a first requested link between the reporting affiliated non-AP station and a reporting affiliated AP addressee of the ML association request frame and additional requested links between reported affiliated non-AP stations and reported affiliated APs of the AP MLD, wherein ML association response frame accepts the first requested link and a subset of the additional requested links with reported affiliated APs.

36. The method of claim 4, wherein the ML association request frame indicates a first requested link between the reporting affiliated non-AP station and a reporting affiliated AP addressee of the ML association request frame and additional requested links between reported affiliated non-AP stations and reported affiliated APs of the AP MLD, wherein ML association response frame accepts the first requested link and a subset of the additional requested links with reported affiliated APs.

37. A wireless communication device comprising at least one microprocessor configured for carrying out the method of claim 2.

38. A non-transitory computer-readable medium storing a program which, when executed by a microprocessor or computer system in a wireless device, causes the wireless device to perform the method of claim 2.
